(19) United States
(12) Patent Application Publication
(10) Pub. No.: US 2006/0212665 A1
(43) Pub. Date: Sep. 21, 2006

(54) SYSTEM AND METHOD FOR ONLINE FIRMWARE UPDATE AND ON-SCREEN-DISPLAY PARAMETERS MODIFICATION

(76) Inventors: Sheng-Hung Lin, Taichung City (TW); Yaw-Tzong Huang, Changhua County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,251

(22) Filed: Dec. 21, 2005

Related U.S. Application Data
(63) Continuation of application No. 10/064,615, filed on Jul. 31, 2002.

(30) Foreign Application Priority Data
May 24, 2002 (TW) 911111029

(51) Int. Cl. G06F 13/00

(52) U.S. Cl. 711/154

(57) ABSTRACT

An online firmware update system and its control interface. The control interface couples to microprocessor, built-in storage unit, and rewritable memory. The control interface includes multiplexer, control register, and bus interface unit. The multiplexer includes selection terminal, output terminal, and control signal input terminal. When the control signal enables the selection terminal, a write signal is sent to the rewritable memory. The control register is located in built-in storage unit and coupled to microprocessor and multiplexer. The control register temporarily stores the control signal. The bus interface unit couples to microprocessor, built-in storage unit, and control register in the built-in storage unit. The bus interface unit has a determination rule to define that only when a fetch signal sent by microprocessor is received, and the received control signal is in an enable state, and a fetch address of the microprocessor is equal to mapping address of built-in storage unit.

### CROSS-REFERENCE TO RELATED APPLICATION

This application is a divisional of a prior application Ser. No. 10/064,615, filed Jul. 31, 2002, which claims the priority benefit of Taiwan application serial no. 91111029, filed on May 24, 2002. All disclosures are incorporated herewith by reference.

### BACKGROUND OF THE INVENTION

1. Field of Invention

The present invention generally relates to a system and method for online firmware update and on-screen-display (OSD) parameters modification and its control interface, and more particularly, to a system and method applied in the liquid crystal panel display controller for performing the online firmware update and OSD parameters modification and its control interface.

2. Description of Related Art

The display used currently comprises the traditional Cathode Ray Tube (CRT) type display and the Liquid Crystal Display (LCD). Wherein, the latter one displays information by applying the principle that the rod-shaped crystal molecule changes direction when it is impacted by voltage. It is commonly used in instruments such as the digital watch, the notebook computer, or the desk displaying device. It consumes a very small amount of electrical power, so it is suitable for instruments that demand to be displayed for a long time. Moreover, the notebook computer mostly adopts the Thin-Film Technology Liquid Crystal Display (TFT-LCD) as the display technique currently. With continuous improvement in the brightness and the contrast in development and the advantage of the light weight and small size, it is in place to be the next product to replace the traditional desktop CRT display in the future.

In general, there is a system board behind the LCD panel as shown in FIG. 1, and it is used to connect the personal computer host 130 for controlling a hardware circuit in the display 100 used for displaying data. The system board 120 comprises a Read Only Memory (ROM) 124 that is used to save the main control program, an Electrically Erasable Programmable Read-Only Memory (EEPROM) 123 that is used to save the OSD parameter. The OSD parameters are about the parameters to set the up, down, left and right position of the screen, brightness, contrast, and so on. Wherein, the system board 120 further comprises a controller 121 that is coupled to the personal computer host 130. The controller 121 further comprises a microprocessor unit (MPU) 122 that is used to execute the main control program in the read only memory 124 and control the register of the controller 121 for displaying the screen, also and to read or modify the OSD parameters in the EEPROM 123.

Since the general system board uses read only memory to store the main control program, it is not possible to update/upgrade the main control program stored in it. Moreover, when the main control program is modified, the display cover has to be opened first to upgrade the read only memory. General users seldom open the display cover, the only exception being that the general users may open the display cover to see what happened when the display is out of order. Therefore, users have to bring their display to a vendor to upgrade the main control program saved in the read only memory, and only a vendor has the equipment and knowledge to do so. Also and, in order to have better efficiency, the system manufacturer prefers to directly update the main control program but not unpacking the equipment hosing.

Although it might be workable to use the flash ROM to replace the read only memory to perform the update/upgrade operation when it is considered in normal logic. However, in order to implement such a type of upgrade method, it needs an extra memory 127. This extra memory 127 can be implemented inside the controller 121 or outside of the controller 121, so as to store or register a piece of the update program, as shown in FIG. 2A and FIG. 2B. In FIG. 2A, the extra memory 127 is disposed at the system space outside the controller 121. In FIG. 2B, the extra memory 127 is disposed inside the controller 121. During operation, the portion of the update program is directly used to update the flash ROM 125. Alternatively, it waits until the update operation is performed, wherein the update program originally stored in the flash ROM 125 is copied to the extra added memory 127 for temporary storing via the bus interface unit (BIU) 126, so that the MPU 122 can fetch the update program to update/upgrade the main control program in the flash ROM 125. By this method, after the read only memory is replaced by the flash ROM, the extra memory needs to be added to temporarily store the update program, and this wastes cost. Since the new added memory is not utilized when the main control program is not performing the update/upgrade operation, the cost is increased and the hardware circuit in the system board is extended, as the bus interface unit 126 is inside the controller 121 and used to distribute the path.

If the flash ROM 310 is used to replace the read only memory without adding extra memory to temporarily store the update program, it will cause system malfunction. This is because when the built-in MPU is used to update the main control program or data in the flash ROM 310, the flash ROM 310 has to be erased before the new version of the main control program or data can be written. However, when the flash ROM 310 is performing the erase or write operation, the operations must be performed under the situation when the MPU 300 operates normally. As shown in FIG. 3A, when the MPU 300 erases and writes into the flash ROM 310, the update program code stored in the flash ROM 310 needs to be fetched out from the flash ROM 310 simultaneously. However, when the flash ROM 310 is performing the erase or write operation, since the flash ROM 310 is busy at this moment, the flash ROM 310 cannot perform the fetch operation when the erase operation is running at the same time. This is because the erase time of the general flash ROM is about 100 ms (1 ms=10⁻³ second), the time needed to write one byte is about 20 μs (1 μs=10⁻⁶ second), and the fetch code time of the MPU 300 is about several hundred ns (1 ns=10⁻⁹ second). Thus both the erase time and the write time are greater than the fetch code time. As shown in FIG. 3B resulting from FIG. 3A, after MPU 300 fetches code from time point t0˜t1, the flash ROM 310 demands the erase operation, and takes an erase time t1˜t3. Moreover, during the erase time t1˜t3, since the flash ROM 310 has entered into the busy state already, the MPU 300 is not allowed to fetch next code at time point t1˜t2. Therefore, the MPU 300 cannot execute the program continuously and this may cause the system to malfunction at this moment.

In summary, since the read only memory is used currently in LCD to store the main control program, the display cover has to be opened first to replace the read only memory when the main control program demands an update/upgrade. If the rewritable flash ROM is used to replace the read only memory, extra memory needs to be added to temporarily store the update program that is needed to update/upgrade the main control program. If the flash ROM is used to replace the read only memory without having the extra memory added to temporarily store the update program that is needed to update/upgrade the main control program, this will result in the malfunction of the whole display system.

### SUMMARY OF THE INVENTION

Therefore, the present invention provides a system and method for online firmware update and OSD parameters modification and a control interface used by it. The system and method can be applied in the liquid crystal panel display controller, so that the flash ROM can replace the read only memory to store the main control program without having to open the display cover and neither having to add the extra memory. Moreover, system malfunction does not happen when the flash ROM is performing the update operation. Furthermore, the present invention also can save the OSD parameters stored in the EEPROM into the flash ROM, so that the EEPROM cost can be eliminated.

The present invention provides a system for online firmware update, the system comprising a rewritable memory and a controller, wherein the rewritable memory has a write pin and has a main control program stored in it. The write pin of the rewritable memory can be used to erase the main control program and to have the upgrade main control program write in. The controller coupled to the rewritable memory comprises a built-in storage unit, a microprocessor, and a control interface, wherein the built-in storage unit should be originally existing in the controller. After the access by the MPU, it allows the controller for use to have the normal action and adjust the screen parameters. The original use is not for temporary storing the update program. The invention, particularly, propose to temporarily store the update subroutine of the main control program by using its continuous mapping address of the built-in storage unit. Moreover, the built-in storage unit further comprises a control register to produce a control signal that is needed during update. The control interface coupled to the rewritable memory and the built-in storage unit determines a fetch priority between the built-in storage unit and the rewritable memory and builds up a write channel between the microprocessor and the rewritable memory.

The microprocessor reads the update subroutine stored in the rewritable memory via the control interface, then writes the update subroutine into the continuous mapping address of the built-in storage unit, further fetches and executes the update subroutine stored in the built-in storage unit to write the upgrade main control program into the rewritable memory.

The present invention further provides an online firmware update method, wherein the liquid crystal panel display comprises a controller and a rewritable memory. The online firmware update method comprises the steps of: at first copying the update program in the rewritable memory to the built-in storage unit of the controller; then enabling the control signal of the controller; further calling the update program temporarily stored in the built-in storage unit by using a function call; the update program subsequently erasing the rewritable memory, after the upgrade main control program downloaded online is completed, finally sequentially writing the upgrade main control program into the rewritable memory to accomplish the online firmware update for the rewritable memory.

The present invention further provides an OSD parameters modification system, the configuration is the same as the one mentioned above, therefore, it is not described in detail herein. However, the rewritable memory contains a main control program and an OSD parameter. The controller erases the OSD parameters and writes in the modified OSD parameters via the write pin. The built-in storage unit temporarily stores the overwritten subroutine and the OSD parameters of the main control program by using the continuous mapping address.

The microprocessor can fetch the overwritten subroutine and the OSD parameters stored in the rewritable memory via the control interface. Then, the overwritten subroutine and the OSD parameters are written into the continuous mapping address of the built-in storage unit. The overwritten subroutine is further fetched and executed to write the modified OSD parameters into the rewritable memory.

The present invention further provides an OSD parameters modification method, wherein the liquid crystal panel display system comprises a controller and a rewritable memory. The OSD parameters modification method comprises the steps of: at first copying the OSD parameters and the overwritten program in the rewritable memory to the built-in storage unit of the controller; then updating the OSD parameters stored in the built-in storage unit; further enabling the control signal of the controller; subsequently calling the overwritten program stored in the built-in storage unit by using a function call; finally the overwritten program erasing the storage area of the rewritable memory where the update program is stored to further write a modified on-screen-display parameters into the rewritable memory.

The address to store the update program, the overwritten program and the OSD parameters in the rewritable memory are different from the one used in the built-in storage unit. Moreover, the rewritable memory provided by the present invention may comprise the flash ROM, EEPROM, and so on, which can prevent the data from being vanish while the power interruption.

Furthermore, in order to avoid system malfunction happening in the update or the modification process mentioned above, the internal elements of the control interface must be improved. The control interface couples to the microprocessor, the built-in storage unit, and the rewritable memory. The control interface comprises a multiplexer, a control register, and a bus interface unit.

The multiplexer comprises a first selection terminal, a first output terminal, and a control signal input terminal, wherein the first selection terminal coupled to the microprocessor receives a write signal that is sent from the microprocessor. The first output terminal couples to the write pin of the rewritable memory. The control signal input terminal receives a control signal, and when the control signal enables the first selection terminal, the write signal is sent to the write pin of the rewritable memory via the first output terminal to build up a write channel.

The multiplexer is used to perform a write operation of the rewritable memory, and includes the erase operation and update operation. However, it cannot avoid the system malfunction. Therefore, it demands a control register that couples to the microprocessor and the multiplexer. The control register in the built-in storage unit is used to temporarily store a control signal.

The bus interface unit couples to the microprocessor and the built-in storage unit, wherein the bus interface unit comprises a first determination rule. Under this rule, the fetch code operation can be performed only when all three conditions are valid. The fetch code operation can be performed onto the built-in storage unit only under the conditions where all of the microprocessor issuing a fetch signal, a control signal being enabled, and the fetch address sent by the microprocessor being equal to the mapping address of the built-in storage unit are valid. That is, the bus interface unit determines whether the fetch priority of the fetched code is obtained from the built-in storage unit or the rewritable memory by using the received control signal.

The control interface only performs the write operation of the rewritable memory and the preferred fetch code operation of the built-in storage unit. However, before these operations can be performed, the update program or the overwritten program and the OSD parameters need to be read out from the rewritable memory, so that the subsequent operations can be performed. In the prior art, the fetch code operation of the rewritable memory can be performed, however the data read operation of the rewritable memory is not allowed.

Therefore, it is necessary to add an AND gate circuit to the control interface to read the data in the rewritable memory. The AND gate circuit comprises a first receiving terminal, a second receiving terminal, and an output terminal. The first receiving terminal coupled to the microprocessor receives a read signal of the microprocessor. The second receiving terminal coupled to the microprocessor receives a fetch signal of the microprocessor. The output terminal coupled to the rewritable memory outputs the read signal or the fetch signal to the rewritable memory.

In summary, the present invention uses the rewritable memory to replace the traditional read only memory to store the main control program, the update program and the overwritten program, and the rewritable memory can be used to further store the OSD parameters without the help of EEPROM. Moreover, in the update and modification process, the built-in storage unit, which has been originally included in the control, is used to replace the extra memory and to temporarily store the update program, the overwritten program and the OSD parameter, so that system malfunction does not happen anymore in the update or modification process.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention. In the drawings,

FIG. 1 schematically shows a block diagram of a conventional liquid crystal panel display;

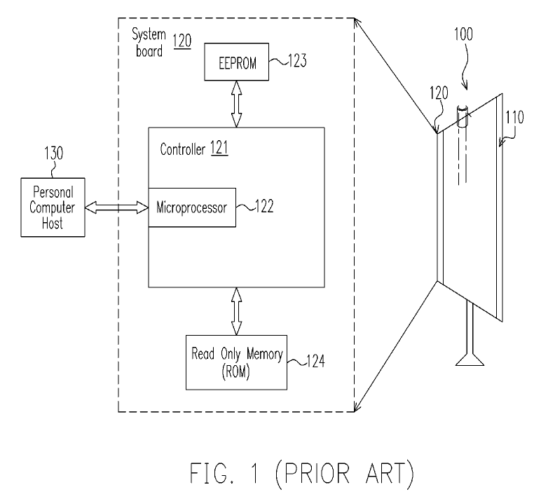

FIGS. 2A-2B schematically show a block diagram of the present invention that assumes a flash memory in the liquid crystal panel display stores the main control program, wherein it demands adding the extra memory to temporarily or always store the update subroutine;

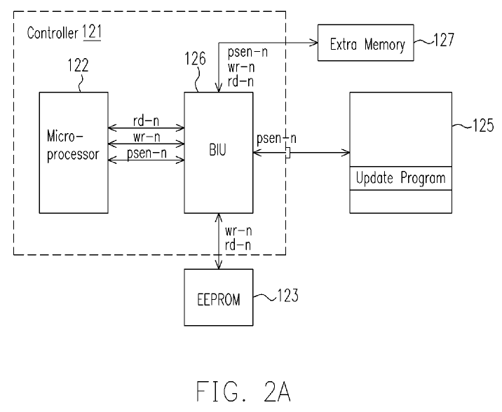

FIG. 3A schematically shows a sketch block diagram of the present invention that assumes a flash memory in the liquid crystal panel display stores the main control program and the update subroutine, wherein it does not demand the extra memory to temporarily or always store the update subroutine;

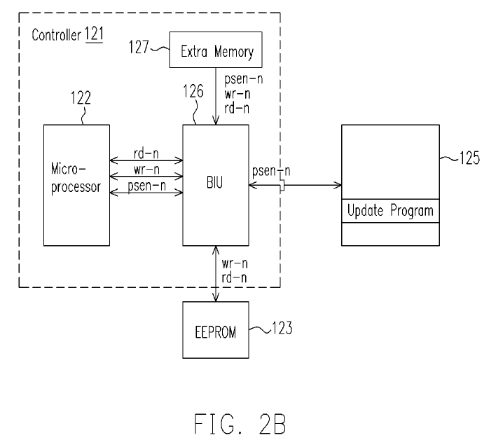

FIG. 3B schematically shows a result from FIG. 3A in the system malfunction;

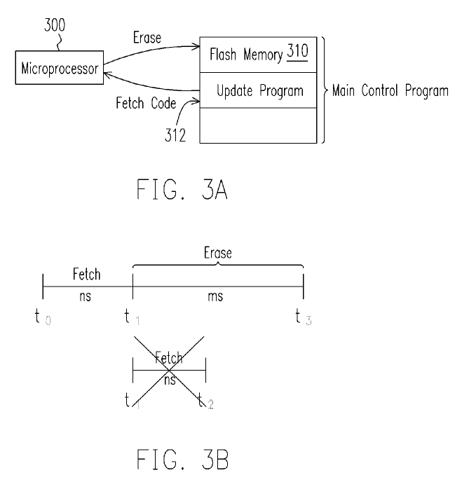

FIG. 4 schematically shows an improved block diagram of a control interface of a preferred embodiment according to the present invention;

FIG. 5 schematically shows an improved block diagram of a control interface of another preferred embodiment according to the present invention;

FIG. 6 schematically shows a full block diagram of a control interface of a preferred embodiment according to the present invention;

FIG. 7 schematically shows a block diagram of an online firmware update system of another preferred embodiment according to the present invention;

FIG. 8 schematically shows a flow chart of a system that performs online firmware update on the host side of a preferred embodiment according to the present invention;

FIG. 9 schematically shows a flow chart of a system that performs online firmware update on the display side of a preferred embodiment according to the present invention;

FIG. 10 schematically shows a sketch map of the present invention when the online firmware update is performing, wherein the transmission sequence and the handshake can be freely arranged;

FIG. 11 schematically shows a flow chart of an OSD parameters modification method of another preferred embodiment according to the present invention; and

FIGS. 12A˜12B schematically shows a sketch map of the present invention that performs the online firmware update and the OSD parameters modification.

### DESCRIPTION OF THE PREFERRED EMBODIMENTS

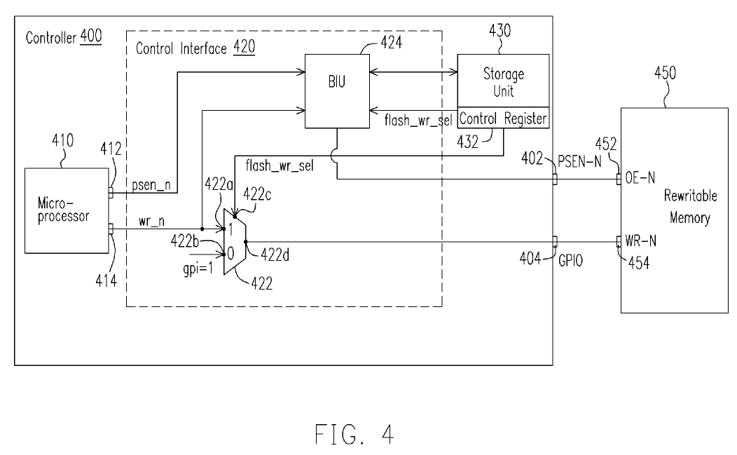

FIG. 4 schematically shows a control interface applied in the liquid crystal panel display of a preferred embodiment according to the present invention. The system board of the liquid crystal panel display comprises a controller 400 and a rewritable memory 450, wherein the rewritable memory 450 can be a flash ROM used to replace the traditional read only memory to store the main control program and also to replace the EEPROM that stores the OSD parameter. The control interface 420 prevents the system malfunction from happening when updating or modifying the main control program and the OSD parameters in the rewritable memory 450.

The control interface 420 coupled to the microprocessor 410, the built-in storage unit 430, and the rewritable memory 450 comprises a multiplexer 422, a control register 432 and a bus interface unit 424.

The multiplexer 422 comprises a first selection terminal 422a and an output terminal 422d. Wherein, the first selection terminal 422a coupled to the microprocessor 410 receives a write signal wr_n sent from the write pin 414 of the microprocessor 410. The output terminal 422d couples to the write pin 454 of the rewritable memory 450. Since the multiplexer 422 is inside the controller 400, the output terminal 422d of the multiplexer 422 couples to the programmable transmission terminal 404 of the controller 400 in the physical connecting circuit. Moreover, the programmable transmission terminal 404 further couples to the write pin 454 of the rewritable memory 450. Here, the programmable transmission terminal 404 is a General Purpose Input Output (GPIO) pin.

The multiplexer 422 further comprises a second selection terminal 422b, the second selection terminal 422b has a default value (the default value is equal to 1), and the malfunction of writing into the rewritable memory 450 does not happen if the default value is setup like this. The control signal input terminal 422a of the multiplexer 422 receives the control signal flash_wr_sel. When the first selection terminal 422a is enabled by the flash_wr_sel signal, the write signal wr-n sent by the microprocessor 410 is sent to the write pin 454 of the rewritable memory 450 via the output terminal 422d of the multiplexer 422 and the programmable transmission terminal 404 coupled to it to build up a write channel.

After the multiplexer 422 is added into the controller 420, the write operation, including the erase operation and the update operation, can be performed onto the rewritable memory. However, this does not prevent the system malfunction from happening, because all of the update subroutine, the overwritten subroutine and the OSD parameters are not copied to the built-in storage unit 430 yet, and thus the rewritable memory 450 is still in the busy state. Therefore, a control register 432 coupled to the microprocessor 410 and the multiplexer 422 and an improved determination rule in the bus interface unit (BIU) have to be used to prevent system malfunction from happening.

The control register 432 in the built-in storage unit 430 is used to temporarily store the control signal flash_wr_sel, and its function is to determine whether the fetch priority of the fetch code is obtained from the built-in storage unit 430 or from the rewritable memory 450. Moreover, when the control signal flash_wr_sel is set in the enable state, the write signal wr_is sent to the rewritable memory 450 via the multiplexer 422 to build up a write channel between the microprocessor 410 and the rewritable memory 450.

The bus interface unit 424 couples to the microprocessor 410, the built-in storage unit 430 and the control register 432 in the built-in storage unit 430, wherein the bus interface unit 424 contains two determination rules, since in the prior art, the bus interface unit is a control circuit for controlling the microprocessor to access data in the built-in storage unit or to fetch the code in the read only memory. In other words, the bus interface unit is a media for communicating with outside, and therefore, there are some determination rules that exist in it, the determination rules comprising:

Determination rule 1: If the microprocessor issues the write signal wr_or read signal rd_n, and the access address of the microprocessor is equal to the mapping address of the built-in storage unit, the data access can only apply to the register and the memory in the built-in storage unit.

Determination rule 2: If the microprocessor issues the fetch signal psen_n, it fetches code from the external read only memory, herein the external read only memory has a higher fetch priority.

The write signal wr_, the read signal rd_n, and the fetch signal psen_n provided in the invention are, for example, belonging to a low level activated signals.

However, the present invention not only fetches code from the external rewritable memory that replaces the read only memory, but it also fetches code from the internal storage unit 430. Therefore, if the old determination rule is adopted (determination rule 2), after the microprocessor 410 uses its fetch pin 412 to issue a fetch signal psen_n, and the bus interface unit 424 receives this fetch signal psen_n, the determination rule 2 determines whether the fetch signal psen_n is sent to the built-in storage unit 430 rather than sent to the built-in storage unit 430 to fetch the code.

Therefore, the present invention improves the former determination rule 2, that is:

Determination rule 2: After the microprocessor issues the fetch signal psen_n, if the control signal flash_wr_sel is in the disable state (i.e. the setting value is equal to 0), the code is fetched from the external rewritable memory 450, and herein the external rewritable memory 450 has a higher fetch priority.

Otherwise, from this determination rule, after the microprocessor issues the fetch signal psen_n, if the control signal flash_wr_sel is in the enable state (i.e. the setting value is equal to 1), the external rewritable memory 450 does not always have the fetch priority. At this moment, the bus interface unit 424 subsequently determines whether the fetch address sent by the microprocessor 410 is equal to the mapping address addr_map of the built-in storage unit 430 or not. Only when the fetch address addr issued by the microprocessor 410 is not equal to the mapping address addr_map of the built-in storage unit 430, can the code be fetched from the rewritable memory 450. Otherwise, the code is fetched from the built-in storage unit 430.

By using the control signal flash_wr_sel and the improved determination rule in the bus interface unit 424 mentioned above, the right to fetch code does not exclusively belong to the rewritable memory 450. Therefore, when the rewritable memory 450 is performing the erase or update operation, the original problem where the microprocessor 410 cannot fetch the next code further resulting in the system malfunction caused by the rewritable memory 450 being busy and not being able to perform the code fetch does not happen any more.

The control interface 400 mentioned above only accomplishes the write operation of the rewritable memory and the preferred fetch code operation of the built-in storage unit. However, before these operations are performed, the update subroutine or the overwritten subroutine and the OSD parameters must be read out from the rewritable memory, so that the subsequent operations can be performed. However, in the prior art, the code can be fetched out from the rewritable memory, but the data can not be read out from the rewritable memory.

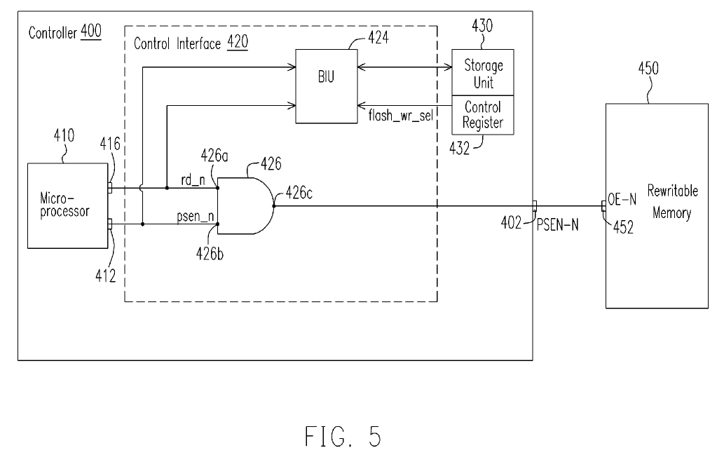

Therefore, the present invention improves on the circuit diagram shown in FIG. 4. As shown in FIG. 5, an AND gate circuit 426 is added into the control interface 420 to read the data stored in the rewritable memory 450. The AND gate circuit 426 comprises a first receiving terminal 426a, a second receiving terminal 426b, and an output terminal 426c, wherein the first receiving terminal 426a coupled to the microprocessor 410 receives the read signal rd_n sent by the read pin 416 of the microprocessor 410. The second receiving terminal 426b coupled to the microprocessor 410 receives the fetch signal psen sent by the microprocessor 410. The output terminal 426c coupled to the rewritable memory 450 outputs the read signal rd_n or the fetch signal psen_n to the rewritable memory 450. The output terminal 426c couples to the fetch pin oe_n 452 of the rewritable memory 450 via the PSEN_N pin 404 of the controller 400.

The read signal rd_n sent by the microprocessor 410 will not be sent out with the fetch signal psen_n at the same time. Since the read signal rd_n sent by the microprocessor 410 is sent to the rewritable memory 450 and the bus interface unit 424, and the bus interface unit 424 further sends this read signal rd_n to the built-in storage unit 430. Therefore, both the rewritable memory 450 and the built-in storage unit 430 send the data back to the bus interface unit 424 (the data transmission paths are not shown in the diagram), and the bus interface unit 424 then determines whether the read address of the microprocessor 410 is equal to the mapping address addr_map of the built-in storage unit 430 or not, according to the determination rule 1. If it is, the data sent by the built-in storage unit 430 is read out. Otherwise, the data stored in the rewritable memory 450 is read out.

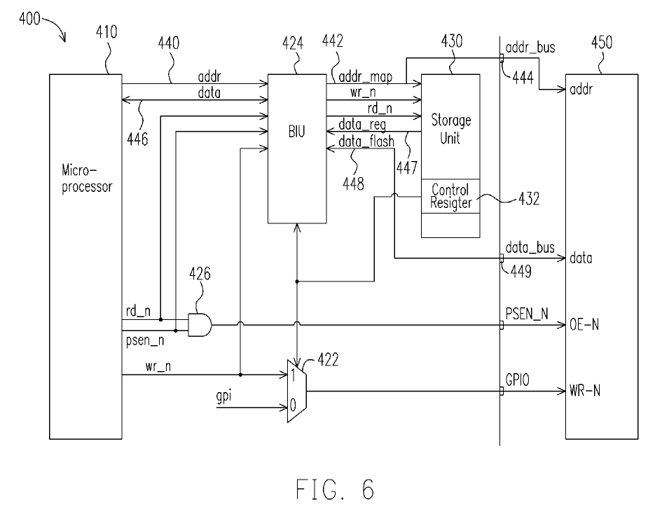

FIG. 6 schematically shows a full circuit of the controller 400. The control interface 420 in FIG. 6 is composed of the bus interface unit 424, the multiplexer 422, and the AND gate circuit 426 of FIG. 6. Moreover, FIG. 6 also shows the address bus and the data bus in between the elements.

After accomplishing the data read out and write in from/to the rewritable memory and the code fetch from the built-in storage unit, and also solving the system malfunction problem that happens in the modification or update, the present invention further applies it to the main control program update/upgrade and the OSD parameters modification.

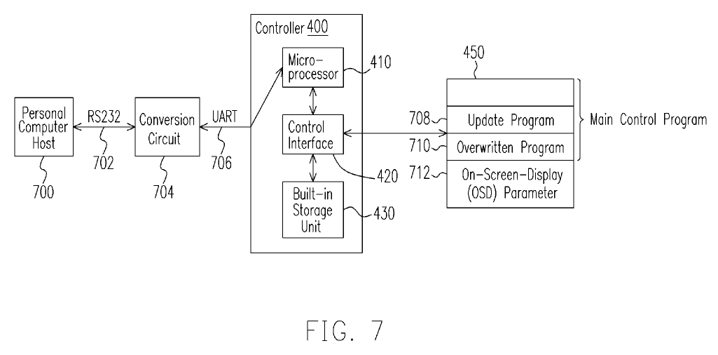

FIG. 7˜10 schematically show a block diagram of an online firmware update system and a flow chart of an online firmware update method that applies to the liquid crystal panel display of a preferred embodiment according to the present invention.

The online firmware update system comprises a rewritable memory 450 and a controller 400, wherein the rewritable memory 450 has write pin (not shown in the diagram) and the contents of a main control program in it. The main control program can be erased and an upgrade main control program can be written in from the write pin of the rewritable memory 450. The controller 400 coupled to the rewritable memory 450 comprises a built-in storage unit 430, a microprocessor 410, and a control interface 420, wherein the built-in storage unit is the registers and the memory that was originally built inside the controller 400. The data stored in the registers and memory has its original objective. It is mainly used to allow the functions such as the chip to be normally operated, the LCD to normally display the screen, adjustment, OSD window display, and so on.

When the user presses the OSD button, the microprocessor 410 will write the OSD displaying data of the main control program into the built-in store unit 430. The controller 400 then can display the OSD window on the LCD, according to the OSD displaying data stored in the built-in store unit 430. When the usr intends to change the screen parameters 712 via the OSD window, then the user can input different quantities for the parameters in the OSD window and then leaves the OSD window. At this moment, since the OSD window is not needed, then the continuous mapping address addr_map of the OSD displaying data stored in the built-in store unit 430 can be used to temporarily store some subroutine and parameters, such as 710, 712 or 708, of the main control program.

The control interface 420 couples to the rewritable memory 450, the built-in storage unit 430, and the microprocessor 410. The built-in storage unit 430 comprises a control register (not shown in the diagram) that is used to temporarily store the control signal. When the control interface 420 receives the control signal that is temporarily stored in the control register (not shown in the diagram) of the built-in storage unit 430, whether the fetch priority belongs to the built-in storage unit 430 or belongs to the rewritable memory 450 can be determined. The write channel between the microprocessor and the rewritable memory also can be built up.

As shown in FIG. 7, the display system board that is composed of the controller 400 and the rewritable memory 450 and the personal computer host 700 are linked by a conversion circuit 704. By using the hand-shaking communication protocol defined by the software on both sides, the upgrade main control program that is to be updated is sent from the personal computer host 700 to the liquid crystal panel display controller 400. The controller 400 subsequently writes the upgrade main control program into the rewritable memory 450.

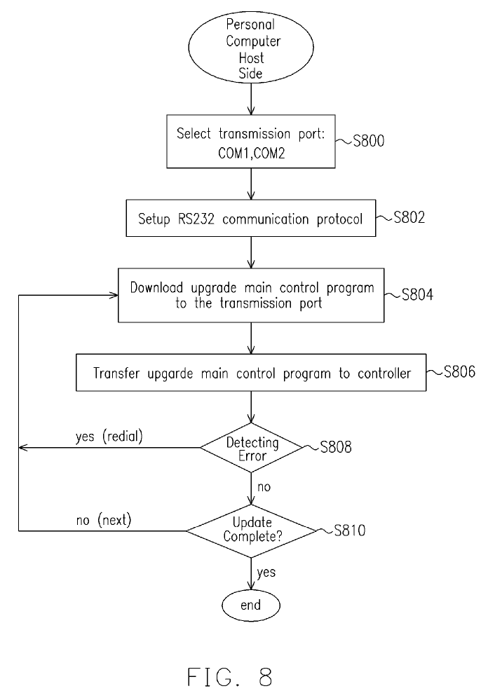

Referring to FIG. 7 and FIG. 8, FIG. 8 shows a flow chart of a program flow that uses software to setup the personal computer host 700. At first, in step s800, the serial transmission port such as COM1 or COM2 transmission port is selected. Then in step s802, the RS232 communication protocol such as the baud rate and the transmission mode are setup. Afterwards in step s804, the upgrade main control program in the personal computer host 700 is loaded to the transmission port. In step s806, the upgrade main control program in the personal computer host 700 is sent to the microprocessor 410 of the controller 400 with the predefined baud rate and transmission mode. When a transmission error has been detected in step s808, then procedure goes back to the step s804 for again downloading the upgrade main control program. If there is no error occurring, then it goes to the next step S810 to determine whether or not the upgrading is accomplished, that is, the whether or not the upgrade main control program is completely downloaded. If it is not yet, then the process goes back to the step S804 to continuously download. Otherwise, the process goes to the end.

In order to use the old subroutine in the main control program that is currently stored in the rewritable memory 450 to update the upgrade main control program that is downloaded by online to update, the program has to update itself by using the program itself. Since the rewritable memory 450 enters into the busy state when it is running the erase or write operation, it cannot provide the accurate update subroutine, thus resulting in system malfunction. Therefore, the present invention finds a small section of continuous mapping address in the controller 400 to temporarily store the update subroutine 708, so that the microprocessor 410 can fetch the update subroutine 708 that is temporarily stored is the mapping address when the rewritable memory 450 is busy to continuously execute the update subroutine code.

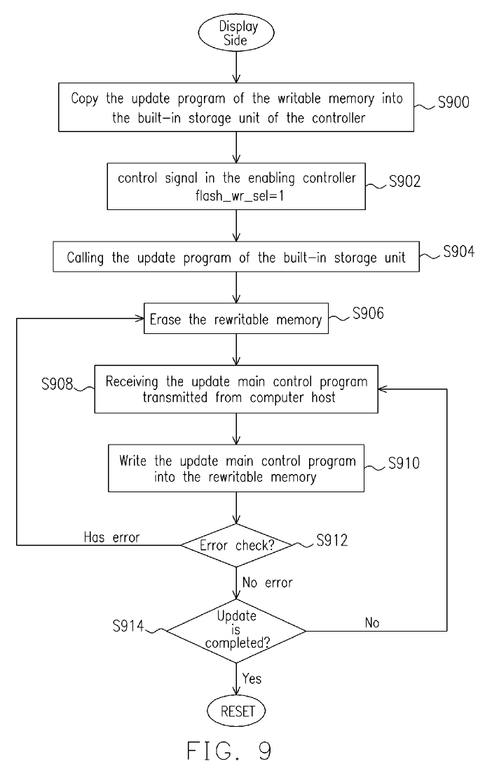

FIG. 7 and FIG. 9 show how the program itself performs the online firmware update operation. The online firmware update method comprises the steps of: first in step s900, the update subroutine 708 in the rewritable memory 450 is copied to the built-in storage unit 430 in the controller 400, wherein the microprocessor 410 reads the update subroutine 708 stored in the rewritable memory 450 via the control interface 420 first, then writes the read update subroutine 708 into the register or the memory of the continuous mapping address in the built-in storage unit 430. Then in step s902, the control signal of the controller 400 is enabled (flash_wr_sel=1), and when the control signal flash_wr_sel is enabled, the update subroutine called by the main control program function is the update subroutine that is copied to and temporarily stored in the built-in storage unit 430 rather than the update subroutine 708 stored in the rewritable memory 450. Since the control signal flash_wr_sel is enabled, under the situation that the fetch address sent by the microprocessor 410 is equal to the mapping address addr_map of the built-in storage unit 430, the update subroutine in the built-in storage unit 430 is fetched.

When the program execution right is transferred to the update subroutine in the built-in storage unit 430, in step s906, the contents of the rewritable memory 450 are erased, and if the rewritable memory 450 is flash ROM, the erase operation is a chip erase, that is the erase operation is performed onto the entire flash ROM. After the upgrade main control program transmitted by the computer host 700 is received in step s908, the upgrade main control program can be sequentially written into the rewritable memory 450 in step s910 to accomplish the online firmware update of the rewritable memory.

After part of the updated main control program is written in step s910, for example, after a number of records of data are written, a checksum error check is performed (step s912). If there is no error and all data are updated (step s914), the system can be rebooted. If there is an error, the error message is displayed by the computer host and the transmission is terminated. The update subroutine in the built-in storage unit 430 may return to step s906 to have the rewritable memory 450 perform the erase and subsequent operation again.

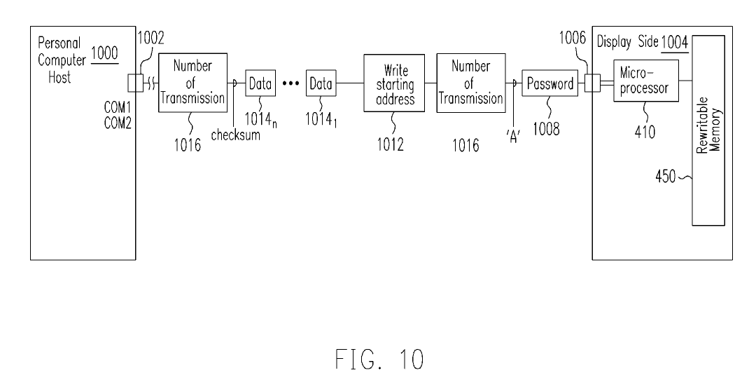

FIG. 10 schematically shows a transmission protocol and the handshake process between the liquid crystal display side 1004 and the personal computer host side 1000.

When the microprocessor 410 of the liquid crystal display side 1004 receives the password information 1008 of the main control program from the D-sub connector 1006, the display side 1004 responds with a response character ‘A’ (41h) to the personal computer host side 1000 after erasing the whole contents of the rewritable memory 450. The personal computer host side 1000 sequentially transfers the data that pertains to the information of the transfer number 1010, the information of the starting address 1012, and the write in information, such as the data 1014₁ to 1014ₙ. After a number of record data are transferred in one transfer operation, for example, after the display side 1004 sequentially writes the data 1014₁ to 1014ₙ into the rewritable memory 450, the checksum is calculated to respond the personal computer host side 1000 to confirm that the accurate data is received.

The present invention further provides an OSD parameters modification system by using the control interface shown in FIG. 7. Its configuration is the same as the one mentioned above, thus it is not described in detail herein. However, the rewritable memory 450 contains the main control program and the OSD parameters 712 that is originally stored in the EEPROM of the prior art. The controller 400 erases the OSD parameters 712 and writes in the modified OSD parameters via the write pin (not shown in the diagram). The built-in storage unit 430 temporarily stores the overwritten subroutine 710 and the OSD parameters 712 of the main control program by using the continuous mapping address.

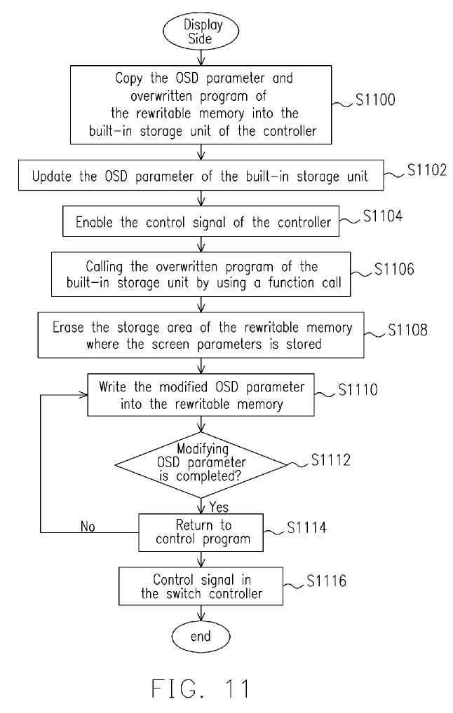

FIG. 11 is used hereinafter to explain the OSD parameters modification process. After the user modifies and saves the OSD parameters in the OSD window, the OSD parameters modification process is performed. At first, the copy step is performed. (s1100), that is the OSD parameters 712 and the overwritten subroutine 710 stored in the rewritable memory 450 are copied to the built-in storage unit 430 in the controller 400. Then the OSD parameters temporarily stored in the built-in storage unit 430 is updated (step s1102). Further, in step s1104, the control signal in the controller 400 is enabled (flash_wr_sel=1). The overwritten subroutine is subsequently called by function (step s1106). The overwritten subroutine called at this moment is the overwritten subroutine in the built-in storage unit 430. The overwritten subroutine subsequently erases the storage area of the rewritable memory 450 where the OSD parameters 712 is stored (step s1108). So that the modified OSD parameters are written into the rewritable memory 450 (step s1110), wherein the method to erase the OSD parameters is a sector erase, and it only erases part of the storage area of the rewritable memory 450. After the OSD parameters modification operation is completed (step s1112), the program control right is returned to the main control program. After that, the control signal of the controller is closed.

In the foregoing descriptions, the location of the built-in storage unit 430 where the update subroutine, the overwritten subroutine, and the OSD parameters are copied into must be properly arranged to avoid the conflict of the address to each other, and resulting in control right of program not being correctly transferred. In addition, it is also necessary to consider whether or not the built-in store unit 430 has sufficient space to store all of the program. Therefore, the space of the built-in store unit 430 shold be repeatedly used.

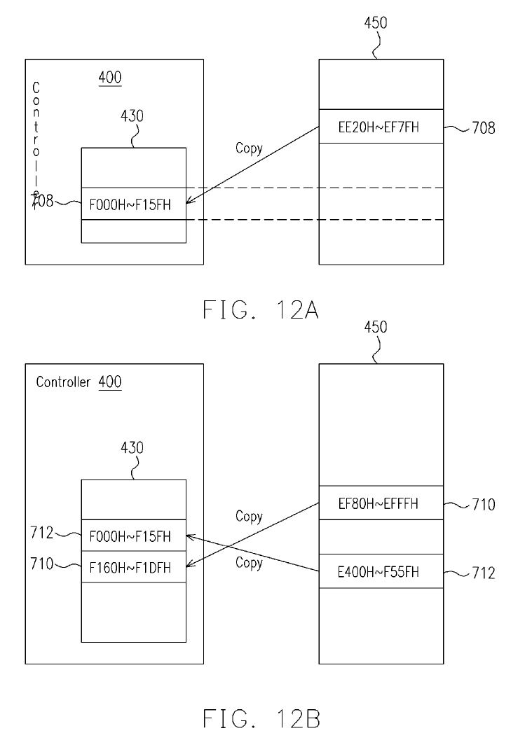

In this embodiment, as shown in FIG. 12A, the address used to store the update subroutine 708 in the rewritable memory 450 is EE20H˜EF7FH. When it is copied to the built-in storage unit 430, it is copied into the address of F000H˜F15FH in the built-in storage unit 430. Moreover, as shown in FIG. 12B, the address used to store the overwritten subroutine 710 in the rewritable memory 450 is EF80H˜EFFFH. When it is copied into the built-in storage unit 430, it is copied into the address of F160H˜F1DFH in the built-in storage unit 430. Similarly, the OSD parameters 712 originally can be stored in the rewritable memory 450 at the address of F400˜F55FH. However, the store address in the built-in store unit 430 is at F000H˜F15FH. In this situation, although the update subroutine 708 and the OSD parameters 712 are all stored in the built-in store unit 430 at the same address, since they are not used at the same time, the conflict will not occur.

In summary, the advantages of the present invention are:

1. The rewritable memory can be used to replace the read only memory to store the main control program without having to open the display cover and to add extra memory.

2. System malfunction does not happen when updating the rewritable memory.

3. The OSD parameters stored in the EEPROM can also be saved in the rewritable memory, so that the EEPROM cost is eliminated.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

What is claimed is:

1. An OSD (On-Screen-Display) parameters modification system, applied in a liquid crystal panel display controller, comprising a controller, the OSD parameters modification system comprising:
a rewritable memory, coupled to the controller, containing a main control program and an OSD parameters with a writing function, wherein the controller erases the OSD parameters from the rewritable memory and writes a modified OSD parameters into the rewritable memory via the writing function;
a built-in storage unit, built inside the controller, temporarily storing an overwritten subroutine of the main control program and the OSD parameters by using a continuous mapping address, wherein the built-in storage unit comprises a control register for temporarily storing a control signal;
a microprocessor, built at outside or inside of the controller; and
a control interface, coupled to the rewritable memory, the built-in storage unit and the microprocessor, wherein the control interface receives the control signal temporarily stored in the control register of the built-in storage unit to determine a fetch priority of the built-in storage unit and the rewritable memory to build up a write channel between the microprocessor and the rewritable memory;
wherein the microprocessor fetches the overwritten subroutine and the OSD parameters stored in the rewritable memory, writes the overwritten subroutine and the OSD parameters into the continuous mapping address of the built-in storage unit, and fetches and executes the overwritten subroutine in the built-in storage unit to write the modified OSD parameters into the rewritable memory.

2. The OSD parameters modification system of claim 1, wherein the type of the rewritable memory comprises a flash-ROM or an EEPROM.

3. The OSD parameters modification system of claim 1, wherein the main control program and the overwritten subroutine have a function call relationship.

4. The OSD parameters modification system of claim 1, wherein the storage address of the rewritable memory used to store the overwritten subroutine and the OSD parameters is different from the storage address of the built-in storage unit used to store the overwritten subroutine and the OSD parameter.

5. The OSD parameters modification system of claim 1, wherein if the control signal is set up in an enable state and a fetch address sent by the microprocessor is equal to the continuous mapping address, the fetch priority belongs to the built-in storage unit.

6. The OSD parameters modification system of claim 1, wherein if the control signal is set up in an enable state and a fetch address sent by the microprocessor is mot equal to the continuous mapping address, the fetch priority belongs to the rewritable memory.

7. An on-screen-display (OSD) parameters modification method, applied in the liquid crystal panel display, wherein the liquid crystal panel display system comprises a controller and a rewritable memory, the OSD parameters modification method comprising the steps of:
copying the OSD parameters and an overwritten subroutine of the rewritable memory into a built-in storage unit of the controller;
updating the OSD parameters of the built-in storage unit;
enabling a control signal of the controller;
calling the overwritten subroutine of the built-in storage unit;
erasing a storage area of the rewritable memory where the OSD parameters are stored; and
writing a modified OSD parameters into the rewritable memory.

8. The OSD parameters modification method of claim 7, wherein the rewritable memory comprises a main control program, the main control program comprises the overwritten subroutine, moreover the main control program and the overwritten subroutine have a function call relationship.

9. The OSD parameters modification method of claim 7, wherein the step of enabling the control signal builds up a write channel between the controller and the rewritable memory.

10. The OSD parameters modification method of claim 7, wherein the storage address of the rewritable memory used to store the overwritten subroutine and the OSD parameters is different from the storage address of the built-in storage unit used to store the overwritten subroutine and the OSD parameter.

11. The OSD parameters modification method of claim 7, wherein the type of the rewritable memory comprises a flash-ROM or an EEPROM.
